(19) United States
(12) Patent Application Publication
(10) Pub. No.: US 2014/0116184 A1
(43) Pub. Date: May 1, 2014

(54) STEERING WHEEL RETENTION ASSEMBLY

(71) Applicants: Michael W. Clark, Essexville, MI (US); Melvin Lee Tinnin, Clio, MI (US)

(72) Inventors: Michael W. Clark, Essexville, MI (US); Melvin Lee Tinnin, Clio, MI (US)

(21) Appl. No.: 13/665,233

(22) Filed: Oct. 31, 2012

(51) Int. Cl. B62D 1/20

(52) U.S. Cl. 74/492

(57) ABSTRACT

A steering wheel retention assembly for retaining a steering wheel hub on a steering shaft of a vehicle steering column includes a mounting portion formed on one of the steering wheel hub and the steering shaft, a receiving portion formed on the other of the steering wheel hub and the steering shaft, and a one-piece retention mechanism positioned in the mounting portion. The retention mechanism includes a resilient locking portion movable between an unlocked position and a locked position. The locking portion projects into the receiving portion in the locked position and is withdrawn from the receiving portion in the unlocked position. The locking portion is biased toward the locked position.

### BACKGROUND OF THE INVENTION

The following description relates to a retention mechanism, and in particular, a retention mechanism for retaining a steering wheel on a steering shaft.

A conventional steering wheel of a vehicle includes a hub that is fixedly attached to a shaft of a steering column with a threaded fastener. The hub typically includes an opening configured to receive the threaded fastener. The shaft typically includes a threaded interior bore configured to threadably receive the threaded faster received through the opening of the hub. Accordingly, the steering wheel may be mounted on the shaft. In other configurations, this arrangement may be reversed, such that the bolt threadably engages the steering wheel hub.

However, during assembly, the threaded fastener may be improperly installed or inadvertently not installed. In addition, the fastener may fail during use due to, for example, improper installation. In such instances, a driver of the vehicle may be able to remove the steering wheel from the shaft thereby presenting safety concerns.

A multi-part latch has been considered. However, multiple manufacturing processes are required to form the multiple parts of the latch which may lead to high manufacturing costs. In addition, a multi-part latch requires assembly which adds complexity to the manufacturing and assembly process of a steering column.

Accordingly, it is desirable to provide a one-piece retention mechanism which may act in place of, or in addition to, the threaded fastener to secure the steering wheel to the shaft. Thus, in the event the threaded fastener is improperly installed or fails during use, unintentional removal of the steering wheel may be avoided.

### SUMMARY OF THE INVENTION

In accordance with an exemplary embodiment, there is a provided a steering wheel retention assembly for retaining a steering wheel hub on a steering shaft of a vehicle steering column. The assembly includes a mounting portion formed on one of the steering wheel hub and the steering shaft, a receiving portion formed on the other of the steering wheel hub and the steering shaft, and a one-piece retention mechanism positioned in the mounting portion, the retention mechanism including a resilient locking portion movable between an unlocked position and a locked position. The locking portion projects into the receiving portion in the locked position and is withdrawn from the receiving portion in the unlocked position. The locking portion is biased toward the locked position.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a retention mechanism of a retention assembly in accordance with an exemplary embodiment of the present invention;

FIG. 2 is rear perspective view of the retention mechanism of FIG. 1 in the retention assembly according to an exemplary embodiment of the present invention;

FIG. 3 is a front perspective view of the retention mechanism of FIG. 1 in the retention assembly according to an exemplary embodiment of the present invention;

FIG. 4 is a partial section view of the retention assembly with the retention mechanism of FIG. 1 in an unlocked position with the steering shaft according to exemplary embodiment of the present invention;

FIG. 5 is a partial section view of the retention assembly with the retention mechanism of FIG. 1 in a locked position according to an exemplary embodiment of the present invention;

FIG. 6 is front view of a partial section of a retention assembly according to a second exemplary embodiment of the present invention;

FIG. 7 is a front perspective view of a retention mechanism and a steering wheel hub of the retention assembly according to the second exemplary embodiment of the present invention;

FIG. 8 is a front perspective view of the retention assembly according to the second exemplary embodiment of the present invention;

FIG. 9 is a front perspective view of a retention mechanism and a steering wheel hub of a retention assembly according to a third exemplary embodiment of the present invention;

FIG. 10 is a partial section view of the retention assembly with the retention mechanism of FIG. 9 in a locked position according to an exemplary embodiment of the present invention;

FIG. 11 is perspective view of a retention mechanism of a retention assembly according to a fourth exemplary embodiment of the present invention;

FIG. 12 is a section view of the retention assembly of FIG. 11 with the retention mechanism in an unlocked position according to the fourth exemplary embodiment of the present invention;

FIG. 13 is a section view of the retention assembly of FIG. 11 with the retention mechanism in a locked position according to the fourth exemplary embodiment of the present invention;

FIG. 14 is a front perspective view of the retention mechanism and the steering wheel hub of the retention assembly according to the fourth exemplary embodiment of the present invention.

FIG. 15 is a front view of a retention assembly according to a fifth exemplary embodiment of the present invention;

FIG. 16 is a section view of the retention assembly according to the fifth exemplary embodiment of the present invention;

FIG. 17 is a perspective view of a variation of the retention mechanism of the retention assembly according to the fifth exemplary embodiment of the present invention;

FIG. 18 is a section view of the retention assembly with the retention mechanism of FIG. 17 according to the fifth exemplary embodiment of the present invention;

FIG. 19 is a perspective view of a retention mechanism of a retention assembly according to a sixth exemplary embodiment of the present invention;

FIG. 20 is a section view of the retention assembly according to the sixth exemplary embodiment of the present invention; and

FIG. 21 is a perspective view of a steering shaft and the retention mechanism of the retention assembly according to the sixth exemplary embodiment of the present invention.

### DETAILED DESCRIPTION

Referring now to the Figures, where the invention will be described with reference to specific embodiments, without limiting same, a retention assembly for a vehicle steering column includes a retention mechanism 110, 210, 310, 410, 510, 610, steering wheel hub 120, 220, 320, 420, 520, 620 and a steering shaft 130, 230, 330, 430, 530, 630. The retention mechanism 110, 210, 310, 410, 510, 610 is configured to retain the steering wheel hub 120, 220, 320, 420, 520, 620 on the steering shaft 130, 230, 330, 430, 530, 630. In an exemplary embodiment, the retention mechanism 110, 210, 310, 410, 510, 610 is formed as one piece. Accordingly, the retention mechanism 110, 210, 310, 410, 510, 610 may formed, for example, in a stamping process and not require any additional assembly. Thus, the retention mechanism 110, 210, 310, 410, 510, 610 may be easily installed and packaged together with a steering shaft or steering wheel hub before final assembly of the steering column.

The retention mechanism 110, 210, 310, 410, 510, 610 may be mounted on a mounting portion 125, 225, 325, 425, 537, 637 of either the steering wheel hub 120, 220, 320, 420, 520, 620 or the steering shaft 130, 230, 330, 430, 530, 630. The retention mechanism 110, 210, 310, 410, 510, 610 includes a resilient locking portion 115, 216, 316, 411, 511, 611 that is configured to engage a receiving portion 137, 237, 337, 438, 523, 623 of the other of the steering wheel hub 120, 220, 320, 420, 520, 620 or steering haft 130, 230, 330, 430, 530, 630. The resilient locking portion 115, 216, 316, 411, 511 611 is configured to move between a first, locking position to hold the steering wheel hub 120, 220, 320, 420, 520, 620 against movement in a removal direction ‘R’ relative to the steering shaft 130, 230, 330, 430, 530, 630 to prevent removal of the steering wheel hub 120, 220, 320, 420, 520, 620 from the steering shaft 130, 230, 330, 430, 530, 630 and a second, unlocking position where the steering wheel hub may be moved in the removal direction such that the steering wheel hub 120, 220, 320, 420, 520 620 may be removed from the steering shaft 130, 230, 330, 430, 530, 630.

FIGS. 1-5 illustrate a retention mechanism and steering assembly according to a first exemplary embodiment of the present invention. In an exemplary embodiment and with reference to FIG. 1, the retention mechanism is formed as a retention clip 110. The retention clip 110 may be formed of an elastically resilient material such as spring steel.

The retention clip 110 includes an attaching section 111 configured to be attached on a steering wheel hub 120. In an exemplary embodiment, the attaching section 111 may include a generally “U” shaped section that is configured to receive a portion of the steering wheel hub 120. The “U” shaped portion includes a main body portion 112 and a latching leg 113 configured to secure the retention clip 110 to the steering wheel hub 120. The retention clip 110 may be formed of an elastically resilient material such as spring steel.

The latching leg 113 is elastically deflectable from a first undeflected position to a second deflected position. In the second position, the latching leg 113 is urged toward the first position under a spring force due to the elastically resilient nature of the material from which the retention clip 110 is made. During mounting on the steering wheel hub 110 the latching leg 113 may be deflected toward the second position. Once mounted on the steering wheel hub 120, the latching leg 113 returns toward the first undeflected position under the spring force. That latching leg 113 further includes a retaining tab 114 formed on a distal end thereof. The retaining tab 114 is configured to retain the retention clip 110 on the steering wheel hub 120 by resisting movement in the removal direction ‘R’.

The locking portion is formed as locking leg 115 extending from the main body portion 112 of the retention clip 110. The locking leg 115 includes a first end 116 attached to the main body portion 112 and a second, free, end 117. The locking leg 115 further includes a locking tab 118 disposed at the second, free end 117. The locking tab 118 includes a service hole 119. The locking tab 118 is configured to engage a steering shaft 130 on which the steering wheel hub 120 is mounted.

The locking leg 115 is elastically deflectable and movable between a first, locking position and a second, unlocking position. The locking leg 115 is urged toward the first, locking position due a spring force resulting from the elastically resilient nature of the material from which the retention clip 110 is made.

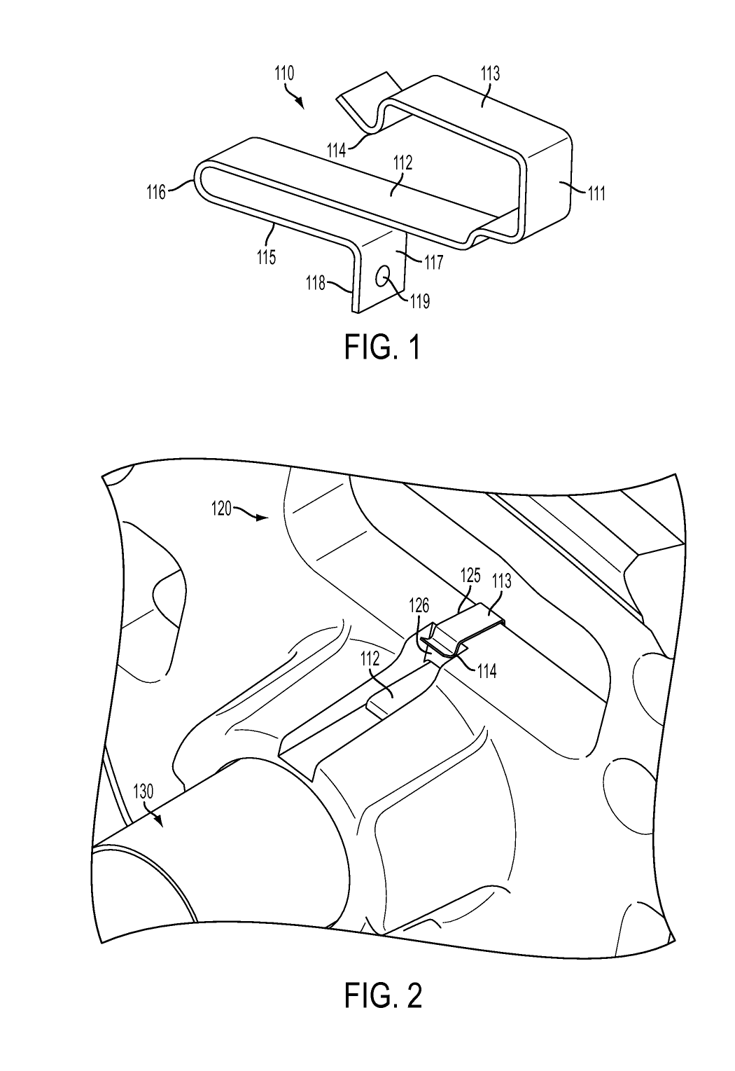

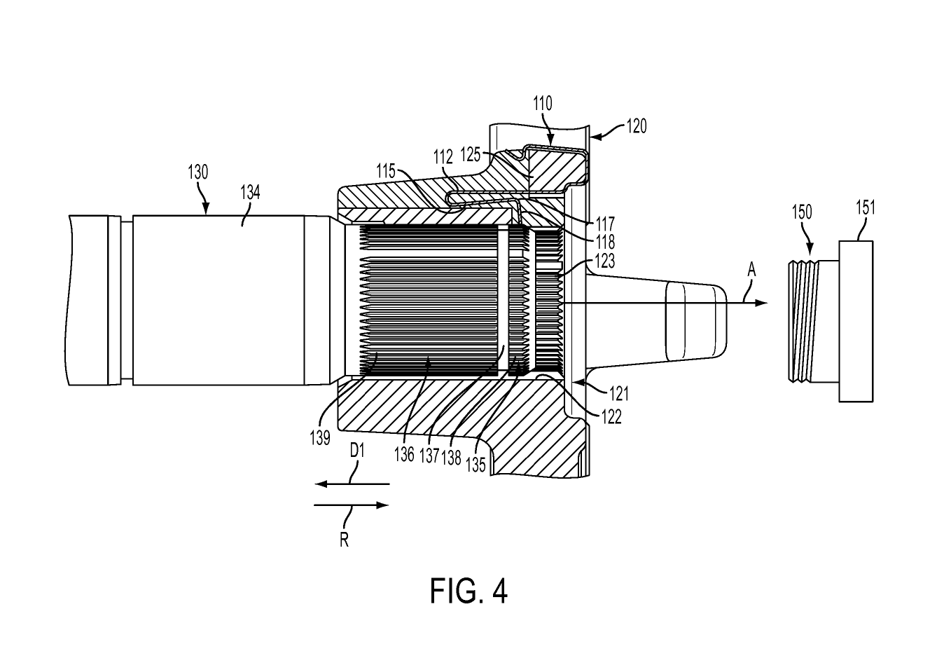

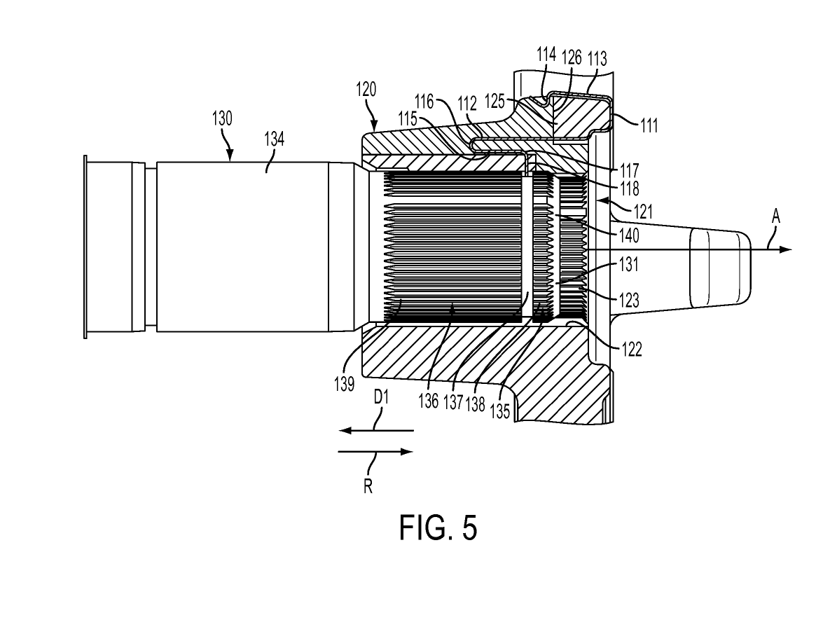

With reference to FIGS. 2-4, the steering wheel hub 120 is configured to be positioned on a steering shaft 130. The steering wheel hub 120 includes an opening 121 defining a radially inward facing surface 122. The opening 121 is positioned about, and extends along an axis ‘A’ (FIGS. 4 and 5). A plurality of circumferentially spaced splines 123 are positioned on the inward facing surface 122 of the opening 121. In an exemplary embodiment, the splines 123 extend in an axial direction, parallel to the axis ‘A’. The opening 121 is configured to receive a portion of the steering shaft 130 to position the steering wheel hub 120 on the steering shaft 130. The opening 121 further includes an axial slot 124 extending radially outward therefrom.

The steering wheel hub 120 also includes a mounting portion 125. The mounting portion includes a section of the axial slot 124 configured to receive the main body portion 112 and the locking leg 115 of the retention clip 110. The mounting portion 125 also includes a portion of the steering wheel hub 120 received in the U-shaped portion of the retention clip 110, i.e., between the main body portion 112 and latching leg 113.

The mounting portion 125 of the steering wheel hub 120 includes a catch surface 126. The catch surface 126 is configured to abut the retaining tab 114 of the latching leg 113 to restrict removal of the retention clip 110 from the steering wheel hub 120. Accordingly, the catch surface 126 and the retaining 114 co-act to retain the retention clip 110 on the steering wheel hub 120.

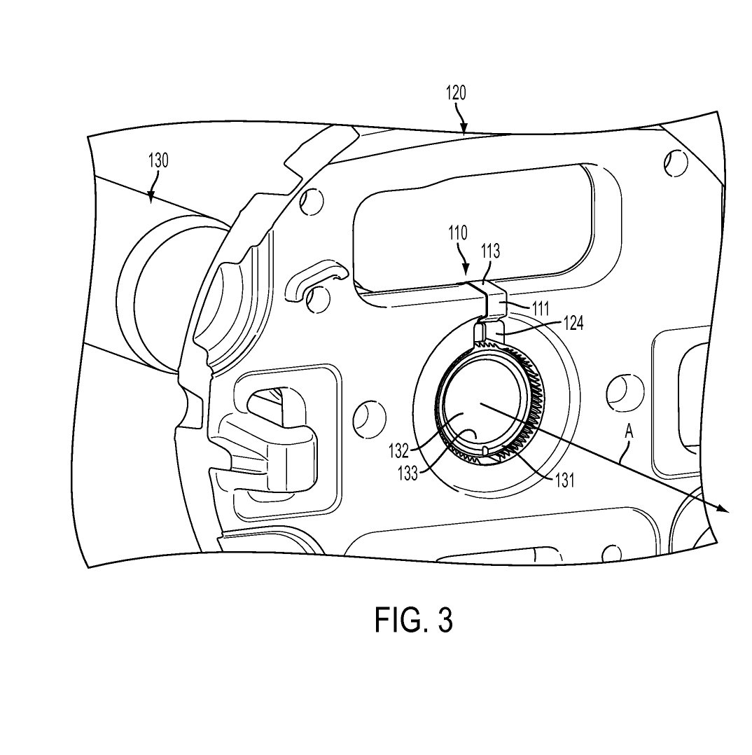

With reference to FIGS. 4 and 5, the steering shaft 130 extends coaxially with the opening 121 of the steering wheel hub 120 along the axis ‘A’ with the hub 120 positioned thereon. The steering shaft 130 has a first end 131 and an internal bore 132 (shown in FIG. 3) defining a radially inward facing surface 133. The bore 132 extends along the axis ‘A’ from the first end 131 within the shaft 130. In an exemplary embodiment, the inward facing surface 133 is threaded at least partially along its length from the first end 131.

The shaft 130 includes an outer surface 134 having a first splined section 135 and a second splined section 136. The first splined section 135 and second splined section 136 are separated by a groove 137. The groove 137 acts a receiving portion and is configured to receive the locking tab 118 of the locking leg 115. The first splined section 135 includes a plurality of circumferentially spaced first splines 138 and the second splined section 136 includes a plurality of circumferentially spaced second splines 139.

In an exemplary embodiment, the first splines 138 and second splines 139 extend axially in the direction of axis ‘A’. The first splines 138 and second splines 139 are equally spaced in the circumferential direction and aligned in the axial direction. The shaft 130 is configured to be received within the opening 121 of the steering wheel hub 120 to position the steering wheel hub 120 on the shaft 130. With the steering wheel hub 120 positioned on the shaft 130, the first splines 138 and second splines 139 are positioned between the splines 123 within the opening 121 of the steering wheel hub 120.

The shaft 130 may include a beveled portion 140 extending from the first end 131 about the circumference of the shaft 130. The beveled portion 140 may extend into the first splined section 135 such that a portion the first splines 138 are included in the beveled portion 140. The beveled portion 140 may assist in positioning the steering wheel hub 120 on the shaft 130 and installation of the retention mechanism 110.

In use, the retention clip 110 is mounted on the steering wheel hub 120. The retention clip 110 is moved relative to the steering wheel hub 120 such that the main body portion 112 passes through the axial slot 124 and the latching leg 113 passes over the mounting surface 125 of the steering wheel hub 120. While passing over the mounting surface 125, the latching leg 113 is deflected toward the second position as shown in FIG. 4. The latching leg 113 moves toward the first position when the retaining tab 114 reaches a position axially beyond the mounting surface 125 of the steering wheel hub 120. In this position, the retaining tab 114 retains the retention clip 110 against removal by abutting catch surface 126 of the steering wheel hub 120.

The steering wheel hub 120 is aligned with the shaft 130 along axis ‘A’ for positioning on the shaft 130. The steering wheel hub opening 121 is moved axially over the shaft 130 in an installation direction ‘D1’ such that the first end 131 of the shaft extends into the opening 121. The locking tab 118 comes into the contact with the first end 131 of the shaft 130, causing the locking leg 115 to deflect toward the second position. In an exemplary embodiment, the locking tab 118 comes into contact with the beveled portion 140 at the first end 131 of the shaft 130.

With reference to FIG. 5, the locking leg 115 deflects toward the second position while the locking tab 118 passes over the first splined section 135. The locking leg 115 moves to the first, locking position when the locking tab 118 is axially positioned at the groove 137. The locking tab 118 is positioned in the groove 137 between the first splined section 135 and second splined section 136. In this position, movement of the steering wheel hub 120 relative to the shaft 130 in a removal direction ‘R’ is restricted due to the engagement of the locking tab 118 within the groove 137.

A service tool (not shown) may be inserted through the axial slot 124 to engage the service hole 119 on the locking tab. The service tool may be used to deflect the locking tab 118, and thus the locking leg 115 to a position radially outside of the groove 137 so that the steering wheel hub 120 may be moved axially relative to the shaft 130.

A threaded fastener 150 may also be received through the opening 121 of the steering wheel hub and threadably engaged within the bore 131 of the shaft. The fastener may include a head portion 151 configured to engage the steering wheel hub 120 when installed to secure the steering wheel hub 120 to the shaft 130.

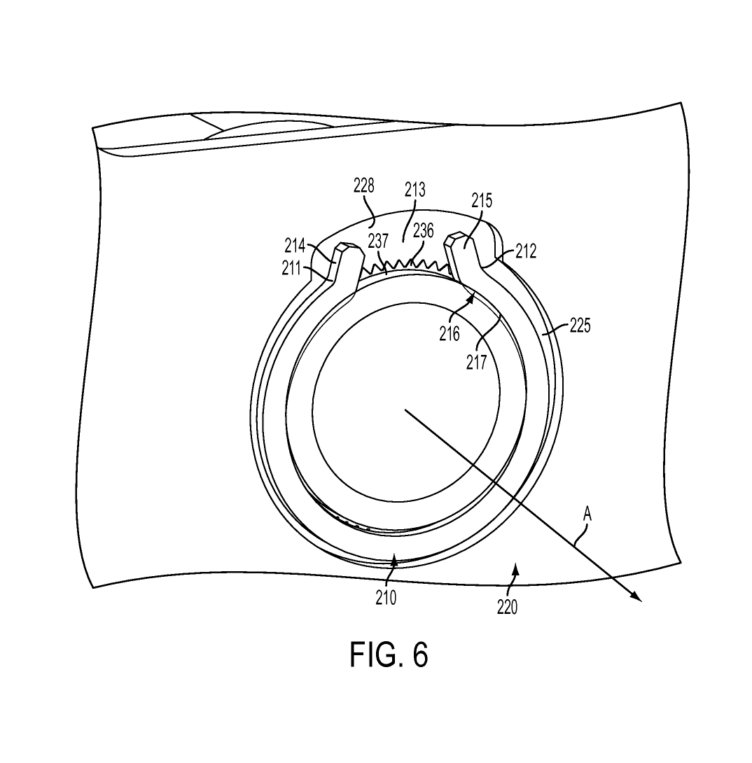

FIGS. 6-8 illustrate a retention mechanism and retention assembly according to a second exemplary embodiment of the present invention. With reference to FIG. 6, in an embodiment, the retention mechanism is a retaining ring 210. The retaining ring 210 is generally partially annularly shaped and includes a first end 211 and a second end 212. The first end 211 and second end 212 are separated by a gap 213. A first tab 214 is disposed at the first end 211 and a second tab 215 is disposed at the second end 212. The retaining ring 210 also includes a locking portion 216. The locking portion 216 includes portions of the first tab 214, second tab 215 and a radially inward surface 217 of the retaining ring. The retaining ring 210 may be formed of an elastically resilient material such as spring steel.

The retaining ring 210 is movable between a first, undeflected position, a second, inwardly deflected position and third, outwardly deflected position. The retaining ring 210 moves from the first position to the second position during installation in the steering wheel hub 220 and the first position and the third position during installation of the steering wheel hub 220 on the shaft 230.

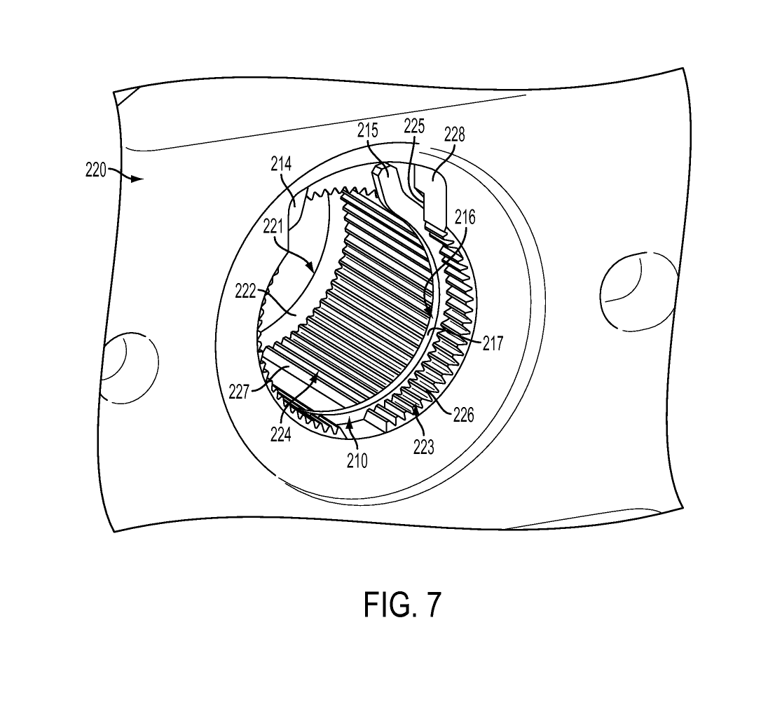

With reference to FIG. 7, the steering wheel hub 220 includes an opening 221 defining a radially inward facing surface 222. The opening 221 is positioned about, and extends along the axis ‘A’. The inward facing surface 222 includes a first splined section 223 and a second splined section 224. The first splined section 223 is separated from the second splined section 224 by a mounting groove 225. In this exemplary embodiment, the mounting groove 225 acts as a mounting portion where the retaining ring 210 may be mounted in the steering wheel hub 220.

The first splined section 223 includes a plurality of circumferentially spaced first splines 226 and the second splined section 224 includes a plurality of circumferentially spaced second splines 227 aligned with the first splines 226. In an exemplary embodiment, the first splines 226 and second splines 227 extend in a direction along the axis ‘A’.

The opening 221 includes a radial slot 228, having an axial component, extending therefrom. The radial slot 228 is positioned so that it intersects the mounting groove 225. In an exemplary embodiment, the radial slot 228 has a circumferential width that is greater than the gap 213 between the first end 211 and second end 212 when the retaining ring 210 is in the first position. Accordingly, the radial slot may 228 allow access to the first tab 214 and second tab 215 when the retaining ring 210 is mounted in the mounting groove 225 of the steering wheel hub.

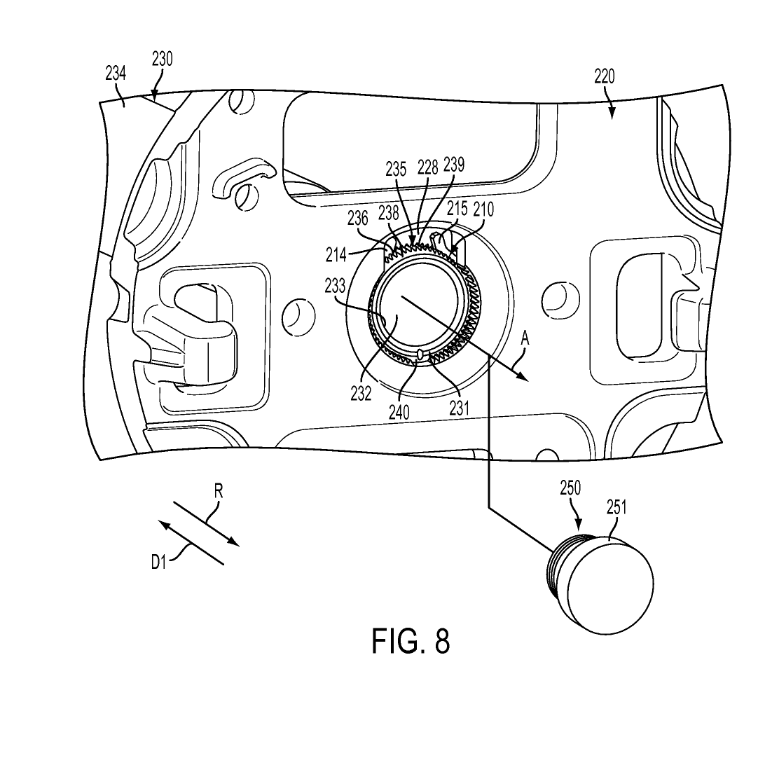

With reference to FIGS. 6 and 8, the steering shaft 230 extends coaxially with the opening 221 of the steering wheel hub 220 along the axis ‘A’. The shaft 230 has a first end 231 and internal bore 232 defining a radially inward facing surface 233 as described above and shown in FIGS. 1-5. The shaft 230 also includes an outer surface 234 having a first splined section 235, a second splined section 236 and a groove 237 as described above and shown in FIGS. 1-5. In this exemplary embodiment, the groove 237 acts as a receiving portion configured to receive the locking portion 216 of the retaining ring 210. The first splined section 235 includes a plurality of circumferentially spaced first splines 238 and the second splined section 236 includes a plurality of circumferentially spaced second splines 239.

The shaft 230 may include a beveled portion 240 extending from the first end 231 about the circumference of the shaft 230. The beveled portion 240 may extend into the first splined section 235 such that a portion the first splines 238 are included in the beveled portion 240. The beveled portion 240 may assist in positioning the steering wheel hub 220 on the shaft 230 and installation of the retention mechanism 210.

In use, the retaining ring 210 may be mounted in the mounting groove 225 within the opening 221 of the steering wheel hub 220. In an exemplary embodiment, the retaining ring 210 is moved to the second, inwardly deflected, or locking, position, and positioned in the mounting groove 225. The retaining ring 210 returns to the first, undeflected position within the mounting groove 225 under the spring force of the material from which the retaining ring 210 is made. When installed in the mounting groove 225, the locking portion 216 of the retaining ring projects partially into the opening 221.

The steering wheel hub 220 is moved axially relative the shaft 230 along the axis ‘A’ in the installation direction ‘D1’ to be positioned on the shaft 230. The retaining ring 210 is moved to the third, outwardly deflected, or unlocking, position upon coming into contact with the first end 231 of the shaft 230, so that the retaining ring 210 may fit over the first splined section 235. The retaining ring 210 returns to the first position upon reaching the groove 237 of the shaft 230. In this position, the locking portion 216 of the retaining ring 210 projects partially into the groove 237 of the shaft 230. Accordingly, due to the positioning in both the mounting groove 225 and groove 237, the retaining ring 210 may restrict movement of the steering wheel hub 220 relative to the shaft 230 in the removal direction ‘R’.

A service tool (not shown) may be inserted through the radial slot 228 to engage the either the first tab 214 or second tab 215 of the retaining ring 210. The service tool may move the retaining ring 210 to the third, outwardly deflected position so that the retaining ring 210 may fit over the first splined section 235 and the steering wheel hub 220 may be removed from the shaft 230.

As described above with reference to FIGS. 1-5, a threaded fastener 250 may also be received through the opening 221 of the steering wheel hub 220 and threadably engage the bore 231 of the shaft 230. The fastener 250 may include a head portion 251 configured to engage the steering wheel hub 120 to secure the steering wheel hub 220 to the shaft 230.

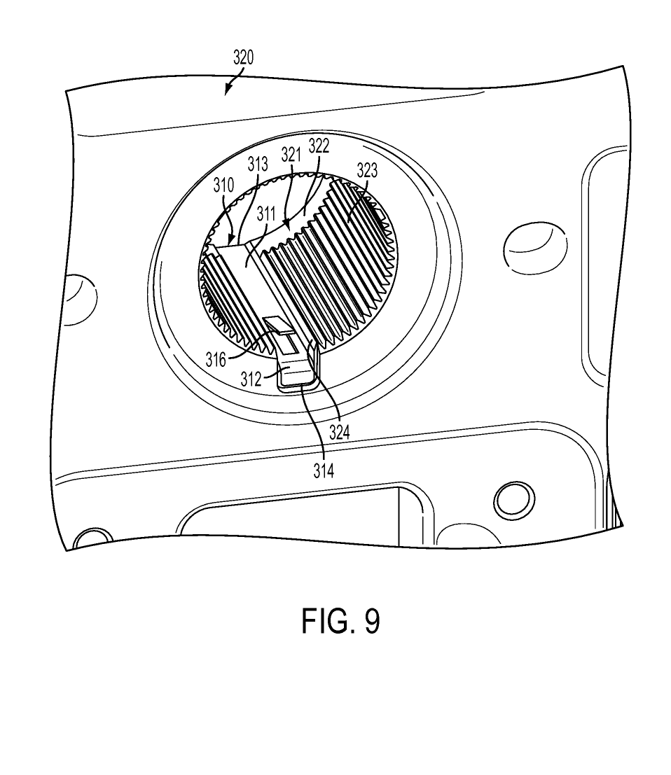

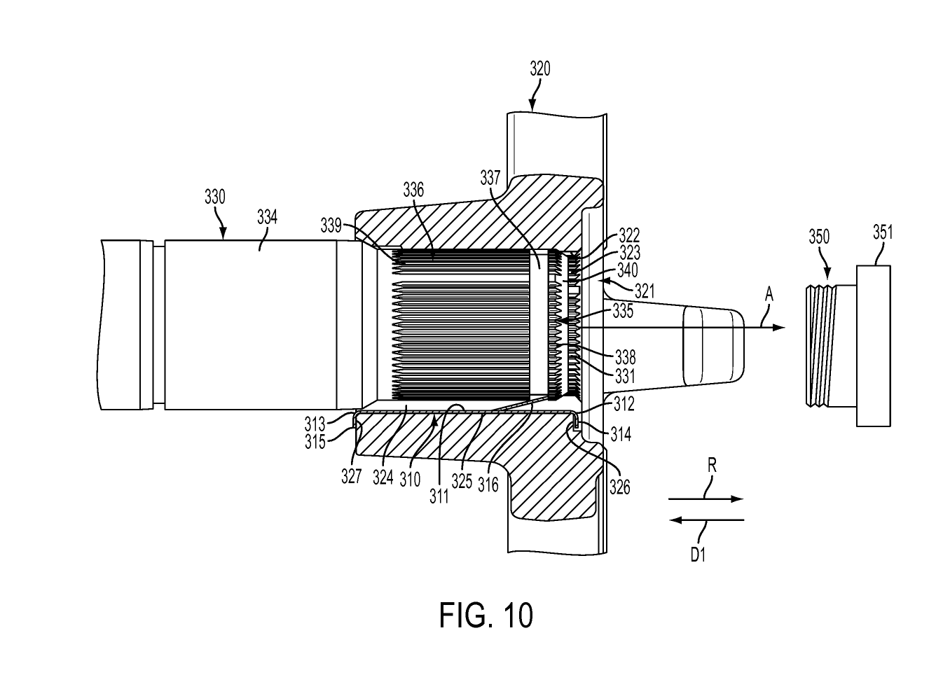

FIGS. 9 and 10 illustrate a retention mechanism and steering assembly according to a third exemplary embodiment of the present invention. In this embodiment, the retention mechanism is formed as a spring clip 310. The spring clip 310 includes an attaching section 311 configured to be mounted on the steering wheel hub 320. The spring clip 310 includes a first end 312 and a second end 313. The first end 312 includes a first mounting tab 314 and the second end 313 includes a second mounting tab 315. The spring clip 310 may be formed of an elastically resilient material such as spring steel.

The locking portion is formed as a locking tab 316 extending from the attaching section 311. The locking tab 316 is elastically deflectable between a first, locking position and a second, unlocking position. The locking tab 316 is urged toward the locking position under a spring force due to the elastically resilient nature of the material from which the spring clip 310 is made.

With reference to FIG. 9, the steering wheel hub 320 includes an opening 321 defining a radially inward facing surface 322. The opening 321 is positioned about, and extends along the axis ‘A’. The inward facing surface 322 includes a plurality of splines 323 circumferentially spaced from one another. In an exemplary embodiment, the splines 323 extend parallel to the axis ‘A’.

The opening 321 includes an axial slot 324 extending radially therefrom. In an exemplary embodiment, the axial slot 324 extends axially along the length of the opening 321. The axial slot 324 includes a mounting portion 325 configured to receive the spring clip 310 so that the spring clip 310 may be mounted therein. The axial slot 324 further includes a first axial end 326 and a second axial end 327.

With reference to FIG. 10, the steering shaft 330 is similar to the steering shaft 130, 230 described in the exemplary embodiments above with reference to FIGS. 1-7. In particular, the steering shaft 330 includes a first end 331, an internal bore (not shown) defining a radially inward facing surface (not shown), and an outer surface 334. The outer surface 334 includes a first splined section 335 and a second splined section 336 spaced from the first splined section 335 by a groove 337. In this exemplary embodiment, the groove 337 acts a receiving portion configured to receive the locking tab 316 of the spring clip 310. The first splined section 335 includes a plurality of circumferentially spaced first splines 338 and the second splined section 336 includes a plurality of circumferentially spaced second splines 339.

In an exemplary embodiment, the first splines 338 and second splines 339 extend axially in the direction of axis ‘A’. With the steering wheel hub 320 positioned on the steering shaft 330, the first splines 338 and second splines 339 are received between respective splines 323 of the opening 321 of the steering wheel hub 320. Accordingly, the steering wheel hub 320 may be substantially rotationally fixed relative to the steering shaft 330.

The shaft 330 may also include a beveled portion 340 extending from the first end 331 about the circumference of the shaft 330 as described in the embodiments above. The beveled portion 340 may assist in positioning the steering wheel hub 320 on the shaft 330 and installation of the spring clip 310.

In use, the spring clip 310 is positioned at the mounting portion 325 in the axial slot 324 such that the first mounting tab 314 is positioned proximate to the first axial end 326 of the axial slot 324 and the second mounting tab 315 is positioned proximate to the second axial end 327 of the axial slot 324. The attaching section 311 extends axially along the axial slot 324. In an exemplary embodiment, the locking tab 316, in the first position, extends at an angle from the attaching section 311 generally radially inward relative to the opening 321 and along an axial distance.

The steering wheel hub 320 may be positioned on the shaft 330 by moving the steering wheel 320 axially along the shaft 330 in the installation direction ‘D1’ with the first end 331 of the shaft received in the opening 321. The locking tab 316 deflects to the second position as it is brought into contact with the first end 331 of the shaft 330, and in an exemplary embodiment, with the beveled portion 340 at the first end of the shaft. Accordingly, the locking tab 316 may move axially along the first splined section 335 when the locking tab 316 is in the second position.

The locking tab 316 moves to the first position when it reaches the groove 337 between the first splined section 335 and second splined section 336 due to a spring force resulting from the resilient nature of the material from which the locking tab 316 and spring clip 310 are made. Here, the locking tab 316 projects into the groove 337 in such way that axial movement of the steering wheel hub 320 in the removal direction ‘R’ is restricted.

A service tool (not shown) may be inserted through the radial slot 324 to engage the first mounting tab 314 of the spring clip 310. The service tool may be used to pry the first end 312 and the retaining tab 314 of the spring clip 310 away from the axial slot 324 in such a way that the locking tab 316 is deflected to the second position. With the retaining tab 314 disengaged from the first end 326 of the axial slot 324, the steering wheel hub 320 may be moved in the removal direction ‘R’.

As described above, and with reference to FIG. 10, a threaded fastener 350 may also be received through the opening 321 of the steering wheel hub 320 and threadably engage the bore 331 of the shaft 330. The fastener 350 may include a head portion 351 configured to engage the steering wheel hub 320 when installed to secure the steering wheel hub 320 to the shaft 330.

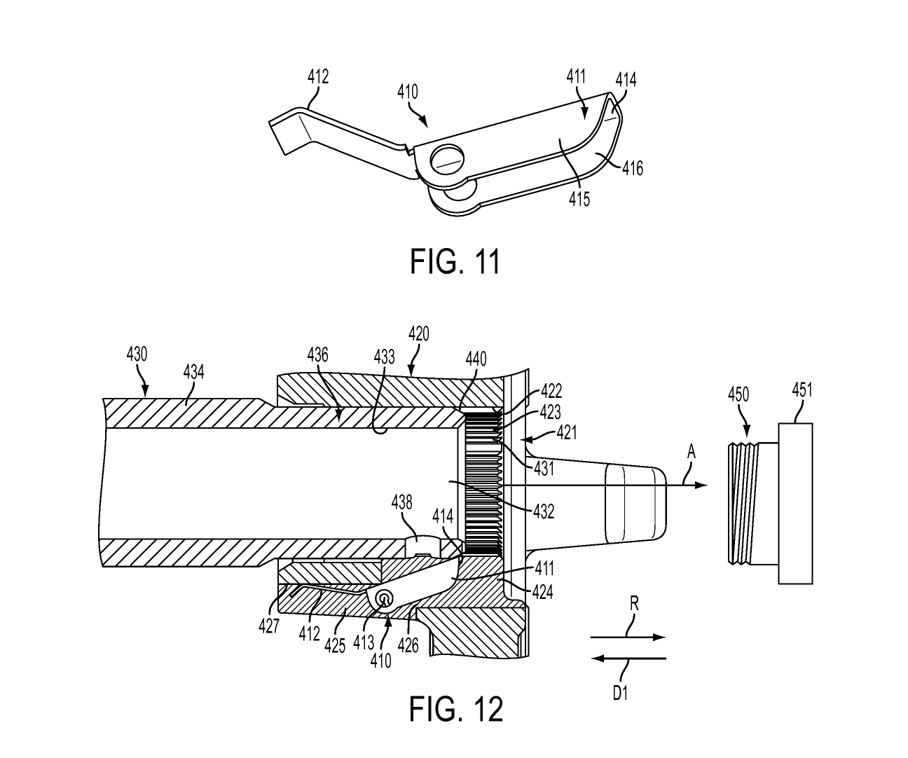

FIGS. 11-14 illustrate a retention mechanism and steering assembly according to a fourth exemplary embodiment of the present invention. In this embodiment, the retention mechanism is formed as a spring loaded catch 410. The spring loaded catch 410 includes a locking tongue 411 and a biasing portion 412 formed integrally, i.e., as one piece, with the locking tongue 411. The locking tongue 411 of the spring loaded catch 410 is the locking portion. The spring loaded catch 410 is configured to rotate about a pivot shaft 413. In addition, the spring loaded catch 410 may be formed of an elastically resilient material such as spring steel.

In an exemplary embodiment, the locking tongue 411 may be generally “U” shaped in cross section. With reference to FIG. 11, the locking tongue 411 may include a locking flange 414, a first side flange 415 and a second side flange 416. The pivot shaft 413 may extend through the first side flange 415 and second side flange 416. In an unloaded condition, the biasing portion 412 extends at angle from the locking tongue 411.

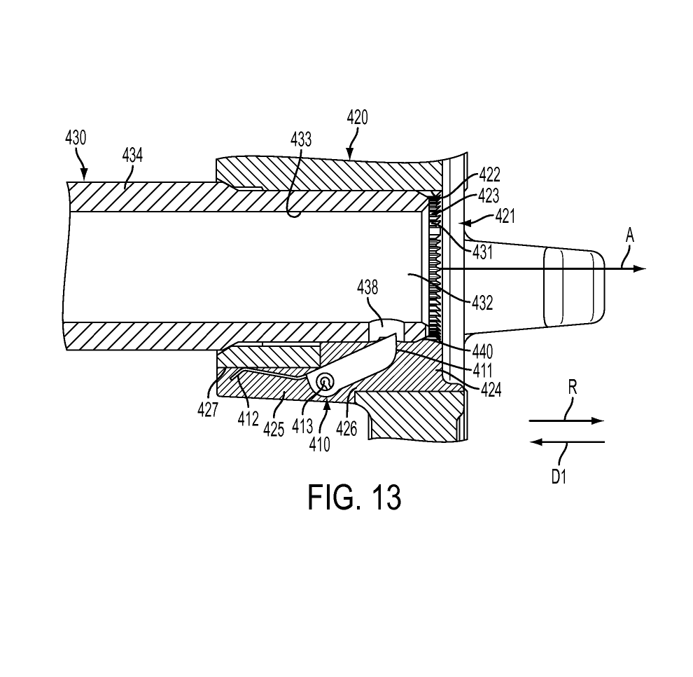

The spring loaded catch 410 is moveable between a first, locking position (FIG. 13) and a second, unlocking position (FIG. 12). The spring loaded catch 410 is urged toward the first position from the second position due to the resilient nature of the material from which the spring loaded catch is made. In an exemplary embodiment, the locking tongue 411 of the spring loaded catch 410 pivots about the pivot shaft 413 when moving between the first position and second position.

With reference to FIGS. 12-14, the steering wheel hub 420 includes an opening 421 defining a radially inward facing surface 422. The opening 421 is positioned about, and extends along the axis ‘A’. The inward facing surface 422 includes a plurality of splines 423 circumferentially spaced from one another. In an exemplary embodiment, the splines 423 extend axially in the direction of the axis ‘A’. The opening 421 also includes a first slot 424 extending at least partially along a length of the opening 421 in the axial direction. The first slot 424 opens towards the opening 421

Referring to FIGS. 12 and 13, the steering wheel hub 420 further includes a mounting portion in the form of a second slot 425 positioned outside of the opening 421. The second slot opens away from the opening 421. The second slot 425 is configured to receive at least part of the spring loaded catch 410 and the pivot shaft 413 such that the spring loaded catch 410 is mounted within the second slot 425.

In an exemplary embodiment, the second slot 425 extends generally in the same direction as the axis ‘A’. In addition, the second slot 425 is positioned to circumferentially align with the first slot 424. A window 426 is positioned in the steering wheel hub 420 such that the first slot 424 and second slot 425 are in communication.

In an exemplary embodiment, the pivot shaft 413 extends across the second slot 425 and is secured within the second slot 425. The spring loaded catch 410 is pivotally mounted on the pivot shaft 413. The biasing portion 412 extends within the second slot 425 and abuts a stop surface 427 of the second slot 425. The locking tongue 411 extends from the pivot shaft 413, through the window 426, and into the first slot 424.

Movement of the locking tongue 411 radially away from a center of the opening 421 moves the spring loaded catch 410 to the second position, as shown in FIG. 12, where it is loaded and urged toward the first position. That is, pivoting the locking tongue 411 away from the center of the opening 421 pivots the biasing portion 412 into the stop wall 427 of the second slot 425, thereby loading the spring loaded catch 410 and urging the spring loaded catch 410 toward the first position.

The steering shaft 430 includes a first end 431, an internal bore 432 defining a radially inward facing surface 433, and an outer surface 434, as described in the exemplary embodiments above. However, in this exemplary embodiment, the steering shaft 430 may include a continuous splined section 436 having a plurality of splines (not shown) similar to the splines shown in the exemplary embodiments above. That is, in this embodiment, the shaft 430 does not necessarily include a first splined section separated from a second splined section by a groove, but rather, includes a continuous splined section 436.

The outer surface 434 of the shaft 430 includes a receiving portion 438. In an exemplary embodiment, the receiving portion 438 is formed as a locking aperture extending through the outer surface 434 and into the bore 432 such that the locking aperture is in communication with the internal bore 432. The receiving portion 438 is configured to receive the locking tongue 411 of the spring loaded catch 410 as shown in FIG. 13.

In an exemplary embodiment, splines (not shown) extend in the direction of axis ‘A’. With the steering wheel hub 420 positioned on the shaft 430, the splines (not shown) are received between respective splines 423 of the opening 421 of the steering wheel hub 420. Accordingly, the steering wheel hub 420 may be substantially rotationally fixed relative to the shaft 430.

The shaft 430 may also include a beveled portion 440 extending from the first end 431 about the circumference of the shaft 430 as described in the exemplary embodiments above.

In use, the steering wheel hub 420 may be positioned on the shaft 430 by moving the steering wheel 420 axially along the shaft 430 in the installation direction D1 with the first end 431 of the shaft 430 received in the opening 421. The locking tongue 411 deflects to the second position when it is brought into contact with the first end 431 of the shaft 430, and in an exemplary embodiment, with the beveled portion 440 at the first end 431 of the shaft 430. In this position, the biasing portion 412 is pressed against a wall in the second slot 425, thereby urging the locking tongue 411 toward the first position via the pivot shaft 413.

The locking tongue 411 returns to the first position when it reaches the receiving portion 438 formed in the shaft 430 under a spring force due to the elastically resilient nature of the material from which the spring loaded catch 410 is made. Here, the locking tongue 411 projects into the receiving portion 438 in such way that axial movement of the steering wheel hub 420 relative to the shaft 430 in the removal direction R is restricted.

A service tool (not shown) may be inserted into the internal bore 432 through the first end 431 of the shaft 430. The service tool may engage the locking tongue 411 through the receiving portion 438 to remove the lock tongue 411 from the locking aperture 438. Accordingly, the spring loaded catch 410 is moved toward the second position. With the spring loaded catch 410 in the second position, the steering wheel hub 420 may be moved axially relative to the shaft 430 in the removal direction ‘R’.

As described above, a threaded fastener 450 may also be received through the opening 421 of the steering wheel hub 420 and threadably engage the bore 431 of the shaft 430. The fastener 450 may include a head portion 451 configured to engage the steering wheel hub 420 when installed to secure the steering wheel hub 420 to the shaft 430.

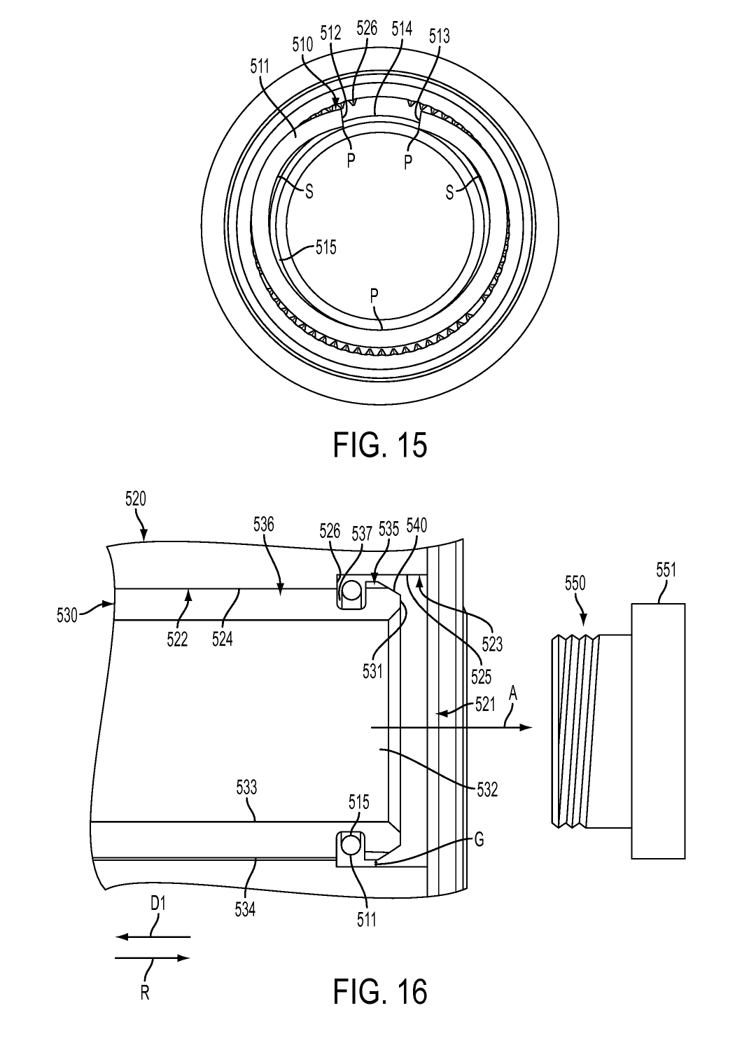

FIGS. 15-18 illustrate a retention mechanism and steering assembly according to a fifth exemplary embodiment of the present invention. In this embodiment, the retention mechanism is formed as an elastically resilient partially annular ring 510. The locking portion is formed as an outer surface 511 of the ring 510 that extends between the steering wheel hub 520 and shaft 530 as described further below.

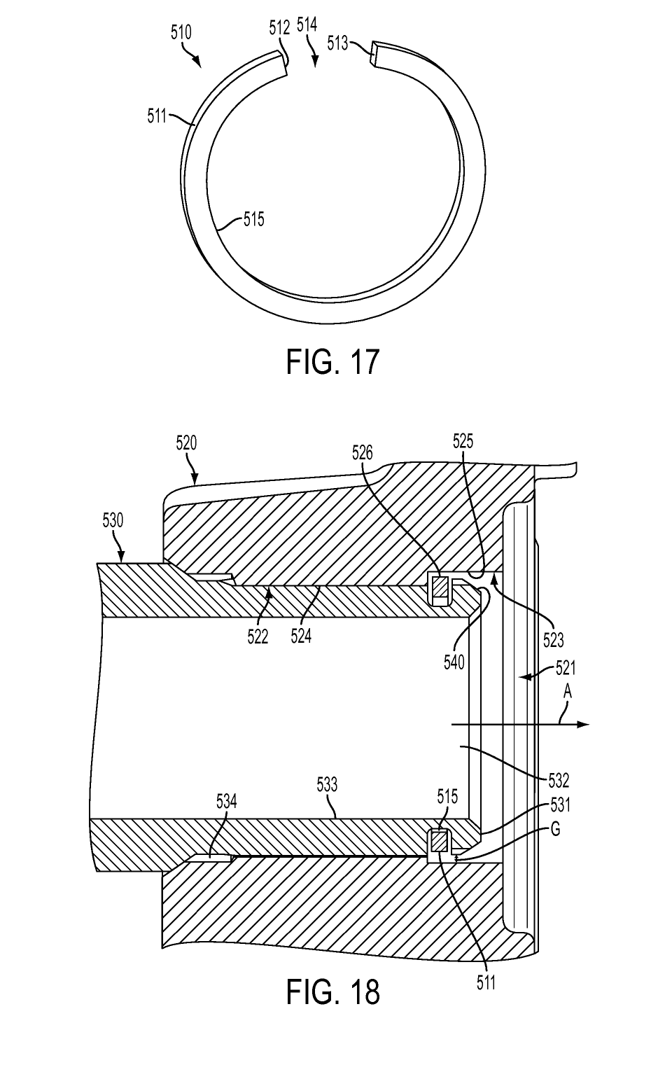

With reference to FIG. 15, the ring 510 includes a first end 512 and a second end 513. The ring 510 is shaped generally partially annularly, which a gap 514 formed between the first end 512 and second end 513. In an exemplary embodiment, the ring 510 has a generally circular cross section. Alternatively, the ring 510 may have another rounded shape or with reference to FIGS. 17 and 18, the ring 510 may have a generally square or other rectilinear cross section. The ring 510 also has a radially inner surface 515.

With reference to FIGS. 16 and 18, the ring 510 is movable between a first, locking position and a second, unlocking position. The ring 510 moves between the first position and second position in response to a force applied from the steering wheel hub 520 when the ring 510 is mounted on the shaft 530. Referring to FIG. 15, in the locking position, the inner surface 515 of the ring 510 contacts the steering shaft 530 at at least one point or section ‘P’ and is spaced from the steering shaft at at least one point or section ‘S’. Where the ring 510 is spaced from the steering shaft 530, outer surface 511 extends beyond a radial extent of the steering shaft 530 and projects into the steering wheel hub 520.

The steering wheel hub 520 includes an opening 521 positioned about, and extending along axis ‘A’. The opening 521 includes a first section 522 and a second section 523. The first section 522 defines a first radially inward facing surface 524 and the second section 523 defines a second radially inward facing surface 525. The second section 523 has a larger diameter than the first section 522. The second section 523 is a receiving portion configured to receive the locking portion or outer surface 511 of the ring 510. An axially facing wall 526 is formed between the first section 522 and second section 523.

The first inward facing surface 524 includes a plurality of splines 526 circumferentially spaced from one another. In an exemplary embodiment, the splines 526 extend axially in the direction of the axis ‘A’.

The steering shaft 530 is similar to the steering shaft 130, 230, 330 described in the exemplary embodiments above with reference to FIGS. 1-10. In particular, the shaft 530 includes a first end 531, an internal bore 532 defining a radially inward facing surface 533, and an outer surface 534. The outer surface 534 includes a first splined section 535 and a second splined section 536 spaced from the first splined section 535 by a groove 537. The groove 537 acts as a mounting portion in which the ring 510 may be mounted. The first splined section 535 includes a plurality of circumferentially spaced first splines (not shown) and the second splined section 536 includes a plurality of circumferentially spaced second splines (not shown), similar to the first and second splined sections discussed in the exemplary embodiments above and as shown in FIGS. 4, 5, and 10.

In an exemplary embodiment, the first splines (not shown) and second splines (not shown) extend axially in the direction of axis ‘A’, similar to the first splines and second splines shown in FIGS. 4, 5 and 10. With the steering wheel hub 520 positioned on the shaft 530, the first splines (not shown) and second splines (not shown) are received between respective splines 523 of the opening 521 of the steering wheel hub 520. Accordingly, the steering wheel hub 520 may be substantially rotationally fixed relative to the shaft 530.

The shaft 530 may also include a beveled portion 540 extending about the first end 531 around the circumference of the shaft 530 as described in the embodiments above. The beveled portion 540 may assist in positioning the steering wheel hub 520 on the shaft 530 and installation of the ring 510.

In use, the ring 510 may be mounted in the groove 537 of the shaft 530. In the first position, the ring 510 has a different degree of curvature than the shaft 530, such that at least one portion of the ring 510 protrudes from the groove 537. The steering wheel hub 520 is moved axially over the shaft 530 in the installation direction D1 along axis ‘A’ such that the shaft 530 is received within the opening 521 of the steering wheel hub 520. The first radially inward facing surface 524 of the first section 522 of the opening 521 compresses the ring 510 to the second position so that the steering wheel hub may be fit over the shaft 530 and ring 510.

The ring 510 moves to the first position when the second section 523 of the steering wheel hub 520 is positioned over the groove 537 of the shaft 530. Here, at least a portion of the ring 510, for example the locking portion or outer surfaces 511, projects into the second section 523 of the opening 521 of the steering wheel hub 520. In this position, axial movement of the steering wheel hub 520 relative to the shaft 530 in the removal direction R is restricted due to the engagement of the ring 510 between the groove 537 and the axially facing wall 526 formed at the boundary between the first section 522 and the second section 523.

A service tool (not shown) may be inserted into the second section 523 of the opening 521. The service tool may include at least one extension that is configured to fit in a radial gap ‘G’ between the first end of the shaft 530 and in the second section 524 to engage and compress a portion of the ring 510 projecting into the second section 524. Accordingly, the ring 510 may be compressed to an extent that the steering wheel hub 520 may be moved axially relative to the shaft 530 in the removal direction.

As described above, a threaded fastener 550 may also be received through the opening 521 of the steering wheel hub 520 and threadably engage the bore 531 of the shaft 530. The fastener 550 may include a head portion 551 configured to engage the steering wheel hub 520 when installed to secure the steering wheel hub 520 to the shaft 530.

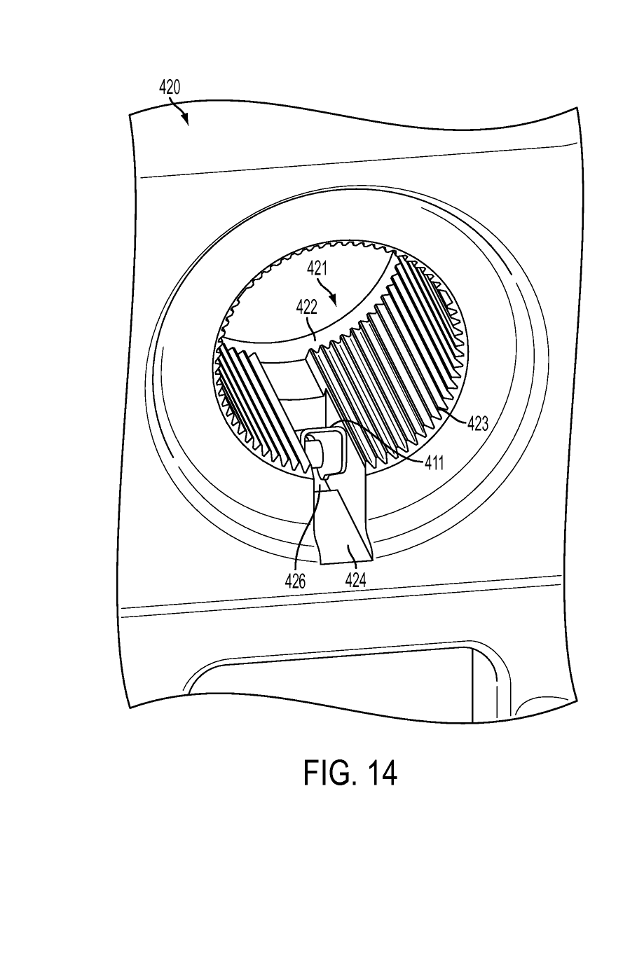

As described above, the cross section of the ring 510 may be generally circular (FIGS. 14 and 15), and generally square or other rectilinear shape (FIGS. 16, 17). The ring 510 with a generally circular cross section may be easier to install. However, the ring 510 with the generally square or rectilinear cross section may be stronger against movement of the steering wheel hub 520 in the removal direction. It is understood that different cross-sectional shapes may be used as well.

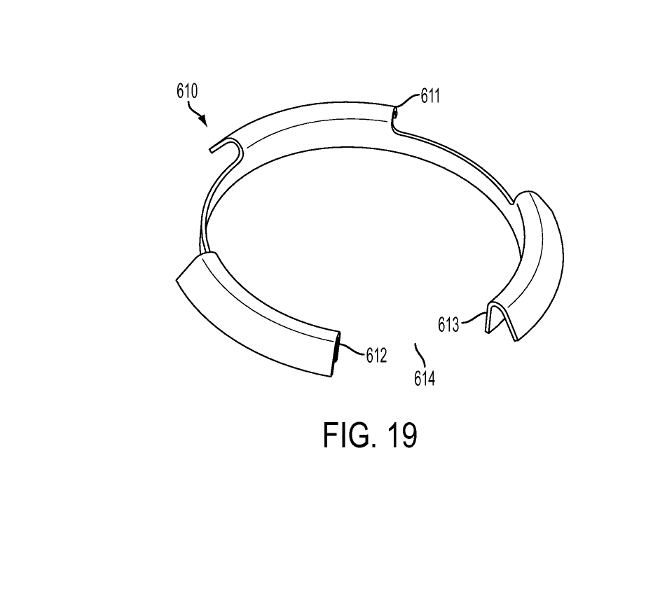

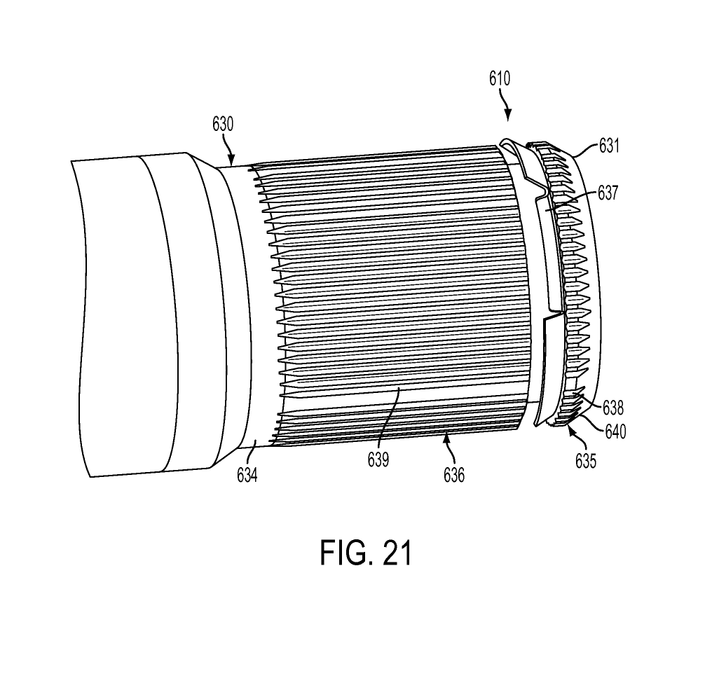

FIGS. 19-21 illustrate a retention mechanism and steering assembly according to a sixth exemplary embodiment of the present invention. In this embodiment, the retention mechanism is formed as a spring clip retaining ring 610. The spring clip retaining ring 610 may be formed of an elastically resilient material such as spring steel.

The spring clip retaining ring 610 includes a locking portion in the form of at least one projection 611. The projection or projections extend outwardly from the spring clip retaining ring 610. In an exemplary embodiment, the spring clip retaining ring 610 includes three projections 611 circumferentially spaced from one another. Each projection 611 is movable between a first, locking position and a second, unlocking position where the projection 611 is urged toward the first position under a spring force due to the elastically resilient nature of the material from which the spring clip retaining ring 610 is made. It is understood that the present invention is not limited to the examples above, and that any suitable number of projections may be used.

The spring clip retaining ring 610 includes a first end 612 and a second end 613. The spring clip retaining ring 610 is shaped generally partially annularly, which a gap 614 formed between the first end 612 and second end 613, to allow for flexibility of the spring clip retaining ring 610.

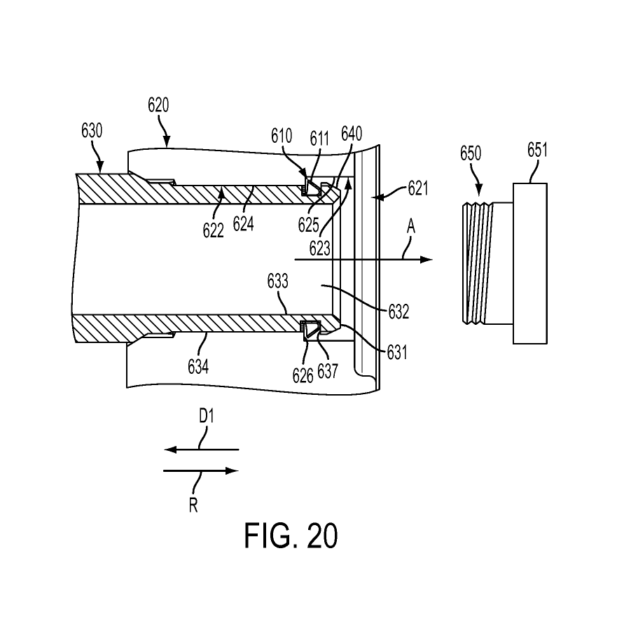

With reference to FIG. 20, the steering wheel hub 620 may be similar to the steering while hub 520 described in the exemplary embodiment above. The steering wheel hub 620 includes an opening 621 positioned about, and extending along axis ‘A’. The opening 621 includes a first section 622 and a second section 623. The first section 622 defines a first radially inward facing surface 624 and the second section 623 defines a second radially inward facing surface 625. The second section 623 has a larger diameter than the first section 622. The second section 623 is a receiving portion configured to receive the locking portion or at least one projection 611 of the spring clip retaining ring 610. An axially facing wall 626 is formed between the first section 622 and second section 623.

The first inward facing surface 624 includes a plurality of splines (not shown) circumferentially spaced from one another. In an exemplary embodiment, the splines (not shown) extend axially in the direction of the axis ‘A’, similar to the splines 227 of the exemplary embodiment shown in FIG. 7.

The shaft 630 is similar to the shaft 130, 230, 330, 530 described in the exemplary embodiments above with reference to FIGS. 1-10 and FIGS. 15-18. In particular, the shaft 630 includes a first end 631, an internal bore 632 defining a radially inward facing surface 633, and an outer surface 634. The outer surface 634 includes a first splined section 635 and a second splined section 636 spaced from the first splined section 635 by a groove 637. The groove 637 acts as a mounting portion in which the spring clip retaining ring 610 may be mounted. The first splined section 635 includes a plurality of circumferentially spaced first splines 638 and the second splined section 636 includes a plurality of circumferentially spaced second splines 639.

In an exemplary embodiment, the first splines 638 and second splines 639 extend axially in the direction of axis ‘A’. With the steering wheel hub 620 positioned on the shaft 630, the second splines 639 are received between respective splines (not shown) of the opening 621 of the steering wheel hub 620. Accordingly, the steering wheel hub 620 may be substantially rotationally fixed relative to the shaft 630.

The shaft 630 may also include a beveled portion 640 extending about the first end 631 around the circumference of the shaft 630 as described in the embodiments above. The beveled portion 640 may assist in positioning the steering wheel hub 620 on the shaft 630 and installation of the spring clip retaining ring 610.

In use, the spring clip retaining ring 610 may be mounted in the groove 637 of the shaft 630. In the first position, the projections 611 of the spring clip retaining ring 610 project beyond a radial extent of the groove 637. The steering wheel hub 620 is moved axially over the shaft 630 along axis ‘A’ in an installation direction Dl such that the shaft 630 is received within the opening 621 of the steering wheel hub 620. The first inward facing surface 624 of the opening 621 acts against the projections 611 to move the projections 611 to the second position such that the steering wheel hub 620 may pass over the spring clip retaining ring 610. The first splines 638 are received between the respective splines in the opening 621 of the hub 620 during movement of the hub 620 in the installation direction D1.

The projections 611 move to the first position due to the spring force of the material from which they are made when the second section 623 within the opening 621 of the steering wheel hub 620 is positioned over the groove 637 of the shaft 630. Here, the projections 611 extend beyond the groove 637 and into the second section 623 of the steering wheel hub 620. In this position, relative axial movement in the removal direction R of the steering wheel hub 620 relative the shaft 630 is restricted due engagement between the projections 611 and the axially facing wall 626.

It is understood that the projections 611 are shaped and configured to move from the first position to the second position upon application of a force in the installation direction D1. Accordingly, the steering wheel hub may be installed on the shaft 630. Conversely, the projections 611 are shaped and configured such that application of a force in the removal direction ‘R’ does not move the projections 611 to the second position. Accordingly, in the event such a force in the removal direction ‘R’ is applied from the steering wheel hub 620, removal of the steering wheel hub 620 is restricted due to an engagement between the axially facing wall 626 and the projections 611.

A service tool (not shown) may be inserted into the second section 623 of the opening 621. The service tool may include at least one extension that is configured to fit in a radial gap between the first end 631 of the shaft 630 and the second inner surface 625 of the second section 623 to engage and compress the projections 611 of the spring clip retaining ring 610. Accordingly, the projections 611 may be compressed to an extent that the steering wheel hub 620 may be moved axially relative to the steering shaft 630 in the removal direction ‘R’ and removed from the steering shaft 630.

As described above, a threaded fastener 650 may also be received through the opening 621 of the steering wheel hub 620 and threadably engage the bore 631 of the shaft 630. The fastener 650 may include a head portion 651 configured to engage the steering wheel hub 620 when installed to secure the steering wheel hub 620 to the shaft 630.

The retention mechanism according to exemplary embodiments of the present invention may be used to secure a steering wheel hub against removal from a steering shaft. The retention mechanism may be used together with a threaded fastener such that the retention mechanism is a redundant fastening device to secure the steering wheel hub on the steering shaft. As a redundant fastening device, the retention mechanism may be used to secure the steering wheel hub on the steering shaft in the event the threaded fastener is improperly installed, fails during use or is not installed.

In the exemplary embodiments above, the retention mechanism may formed as one piece, for example, in a stamping process. Accordingly, the retention mechanism does require any additional assembly. Thus, the retention mechanism may be easily installed and packaged together with a steering shaft or steering wheel hub before final assembly of the steering column. That is, the retention mechanism may be installed on the steering wheel hub or steering shaft before transport to a final assembly site for the steering column. Accordingly, no additional steps may be needed at the final assembly site to assemble the steering column with the retention mechanism described above.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A steering wheel retention assembly for retaining a steering wheel hub on a steering shaft of a vehicle steering column, the assembly comprising:
a mounting portion formed on one of the steering wheel hub and the steering shaft;
a receiving portion formed on the other of the steering wheel hub and the steering shaft; and
a one-piece retention mechanism positioned in the mounting portion comprising a resilient locking portion movable between an unlocked position and a locked position, the locking portion projects into the receiving portion in the locked position and is withdrawn from the receiving portion in the unlocked position, the locking portion biased toward the locked position.

2. The retention assembly of claim 1, wherein the mounting portion is formed on the steering wheel hub, and the steering wheel hub includes an opening extending along an axis, the opening configured to receive the steering shaft.

3. The retention assembly of claim 2, wherein the retention mechanism comprises an attaching section configured to be secured to the mounting portion and the locking portion comprises a locking leg having a first end attached to the attaching section and a second, free end, the locking leg having a locking tab disposed at the second end thereof, the locking tab configured to project into the receiving portion.

4. The retention assembly of claim 3, wherein the receiving portion comprises a groove extending about the circumference of the steering shaft and the groove is configured to receive the locking tab.

5. The retention assembly of claim 3, wherein the attaching section comprises a generally “U-shaped” and is configured to receive the mounting portion of the steering wheel hub to be attached thereto.

6. The retention assembly of claim 2, wherein the retention mechanism comprises a retaining ring formed in a partially annular shape and having a first end with a first tab extending therefrom and a second end with a second tab extending therefrom, the first end spaced from the second end by a gap, and the locking portion comprises a radially inner facing surface of the retaining ring.

7. The retention assembly of claim 6, where the mounting portion comprises a mounting groove formed in the opening of the steering wheel hub and extending in a circumferential direction of the opening.

8. The retention assembly of claim 7, wherein the opening further includes a slot in communication with the mounting groove, wherein the first tab and second tab of the retaining ring are disposed in the mounting groove at a position corresponding to the position of the slot, and the slot extends a distance that is greater than the gap between the first end and second end of the retaining ring.

9. The retention assembly of claim 7, wherein the receiving portion comprises a groove extending about a circumference of the steering shaft and the groove is configured to receive the radially inward facing surface of the retaining ring.

10. The retention assembly of claim 2, wherein the retention mechanism is a spring clip comprising an attaching section having a first end having a first mounting tab and a second end having a second mounting tab, and the locking portion comprises a locking tab extending from the attaching section at an angle.

11. The retention assembly of claim 10, wherein the mounting portion comprises a slot extending in an axial direction of the opening and the slot is configured to receive the spring clip such that the first mounting tab and second mounting tab fix the spring clip against movement in the axial direction within the slot.

12. The retention assembly of claim 11, wherein the receiving portion comprises a groove extending about a circumference of the steering shaft and the groove is configured to receive the locking tab.

13. The retention assembly of claim 2, wherein the retention mechanism comprises a spring loaded catch pivotally mounted on the steering wheel hub, the spring loaded catch comprising a locking tongue and an integrally formed biasing portion extending from the locking tongue at an angle, the biasing portion urging the locking tongue into the receiving portion, the locking portion comprising the locking tongue.

14. The retention assembly of claim 13, wherein a first slot extends axially within and radially outwardly from the opening of the steering wheel hub and the mounting portion comprises a second slot positioned outside of the opening, the second slot facing away from the opening and is in communication with the first slot through a window positioned between the first slot and second slot, the first slot including a pivot shaft upon which the spring loaded catch is mounted.

15. The retention assembly of claim 14, wherein the receiving portion comprises an locking aperture formed in the steering shafting and extending from an outer surface of the steering shaft to an internal bore extending axially though the steering shaft, the locking aperture configured to receive the at least a portion of the locking tongue extending through the window and first slot of the steering wheel hub.

16. The retention assembly of claim 1, wherein the mounting portion is formed on the steering shaft and the steering wheel hub includes an opening extending along an axis configured to receive the steering shaft.

17. The retention assembly of claim 16, wherein the retention mechanism comprises a partially annular ring having a first end, a second end, and a gap formed therebetween, the ring having a radius of curvature such that the ring, in the locked position, includes at least one portion spaced from the steering shaft, and at least one portion in contact with the steering shaft, and the locking portion comprises a radially outer surface of the ring positioned at the at least one portion of the ring that is spaced from the steering shaft.

18. The retention assembly of claim 17, wherein the retention mechanism has a circular cross section.

19. The retention assembly of claim 17, wherein the retention mechanism has a rectilinear cross section.

20. The retention assembly of claim 17, wherein the mounting portion comprises a groove extending about a circumference of the steering shaft and the groove is configured to receive the ring therein.

21. The retention assembly of claim 20, wherein the opening includes a first section having a first diameter and a second section having a second diameter greater than the first diameter, and an axial facing wall is formed between the first section and second section, the receiving portion comprising the second section of the opening, such that the radially outer surface of the ring projects into the second section to prevent removal of the steering wheel hub from the steering shaft.

22. The retention assembly of claim 16, wherein the retention mechanism comprises a partially annular spring clip retaining ring having a first end, a second end, and gap formed between the first end and second end, and further comprising at least one radially outward extending projection, the locking portion comprising the at least one radially outward extending projection.

23. The retention assembly of claim 22, wherein the mounting portion comprises a groove extending about a circumference of the steering shaft and the groove is configured to receive the spring clip retaining ring therein.

24. The retention assembly of claim 23, wherein the opening includes a first section having a first diameter and a second section having a second diameter greater than the first diameter, and an axial facing wall is formed between the first section and second section, the receiving portion comprising the second section of the opening, such that the at least one radially outward extending projection projects into the second section to prevent removal of the steering wheel hub from the steering shaft.

25. The retention assembly of claim 22, wherein the at least one radially outward extending projection comprises three radially outward extending projections spaced apart along the circumference of the spring clip retaining ring.
